(19) United States
(12) Patent Application Publication
(10) Pub. No.: US 2011/0198438 A1
(43) Pub. Date: Aug. 18, 2011

(54) Propulsion and steering system for an airship

(75) Inventor: Hokan Colting, Newmarket (CA)

(73) Assignee: 21st CENTURY AIRSHIP TECHNOLOGIES INC.

(21) Appl. No.: 12/656,884

(22) Filed: Feb. 18, 2010

(51) Int. Cl. B64B 1/00

(52) U.S. Cl. 244/30

(57) ABSTRACT

The present invention relates generally to airships and more precisely, to a propulsion and steering system for use with an airship. The airship possesses a hull having an outer envelope. The propulsion and steering system includes at least one propulsion and steering assembly. The assembly includes an engine for producing thrust to propel the airship and a support frame for carrying the engine. The engine is fixed to the support frame. A support frame movement mechanism is operable to move the support frame relative to the hull to thereby allow the engine and the thrust produced by the engine to be oriented in a desired direction. The assembly further includes spacer means connected to the support frame movement mechanism for spacing the support frame and the engine from the outer envelope of the hull so as to create sufficient clearance therebetween when the support frame is moved. Also provided is a mounting framework for attaching the spacer means to the hull.

### FIELD OF THE INVENTION

The present invention relates generally to airships and more precisely, to a propulsion and steering system for an airship.

### BACKGROUND OF THE INVENTION

Airships were, at one time, the preferred mode of aerial transportation. Originally, airships were steered using rudders similar to rudders of planes. A rudder controls the yaw—rotation about a vertical axis—of the airship by creating sideward lift when traveling through air at a relatively high speed. However, rudders are mostly inefficient at low speeds. This tends to pose a number of problems, notably at landing. For an airship to be able to land at a precise landing site, a substantial ground crew is usually required to ease the airship towards the landing site using ropes tethered to the airship. This problem is further exacerbated when the landing is to be performed in a limited space.

There are additional circumstances where precise positioning control of the airship may be important, for example, when loading or unloading good while hovering, when conducting a geophysical surveys or when the airship is used in search and rescue applications. Conventional airship steering systems tend not to be well-suited for the precisely positioning the airship in these types of applications.

A number of solutions to this problem have been suggested. For instance, Canadian Patent Application No. 2,631,277 of Colting discloses a steering apparatus for an airship which is provided with a plurality of ducts attached to the hull of an airship. Each duct is defined by a sidewall and houses an engine assembly operable to drive a propeller. Each duct includes a closure for occluding outflow from the rear of the duct. Formed in the sidewall of each duct downstream of the propeller is at least one port. A vane is provided for each port to control air flow therethrough. By selectively opening or closing the ports thrust produced by the engine assembly may be oriented radially to the axis of the duct to allow improved control of direction, altitude or attitude of the airship.

While this approach represents a significant advance in the art of airship steering and an improvement over prior art airship steering systems, it tends to experience certain drawbacks. More specifically, air propelled rearward by the propeller tends to lose momentum when it is reoriented or deflected by the vanes, resulting in loss of some thrust and poor efficiency. As a result, to be effective such airship propulsion systems would likely be required to have relatively large engines (preferably, turbo diesels) with very large propellers. Ducts accommodating such engines with very large propellers (e.g. having diameters greater than 10 ft.) would tend be exceedingly heavy thereby tending to increase fuel costs. Due to their significant weight, such ducts would also tend to be difficult to transport from the place of manufacture to the airship assembly site. An additional drawback lies in the fact that steering and propulsion in this manner tends to be limited by the configuration of the vanes since orientation of the thrust produced will depend on the position of the vanes in the duct.

In light of the foregoing, it would be advantageous to have a propulsion and steering system which would allow improved and more efficient deflection of thrust for more controlled steering of an airship at relatively low speeds. Such a system would tend to facilitate the airship landing operation and procedure and obviate the need for having a significant ground crew during airship landings, thereby tending to reduce airship operating costs. Advantageously, such features would enhance the versatility of the airship and allow it to be used for various applications.

### SUMMARY OF THE INVENTION

In accordance with one embodiment of the present invention, there is provided a propulsion and steering assembly for use with an airship. The airship possesses a hull having an outer envelope. The assembly includes an engine for producing thrust to propel the airship and a support frame for carrying the engine. The engine is fixed to the support frame. A support frame movement mechanism is operable to move the support frame relative to the hull to thereby allow the engine and the thrust produced by the engine to be oriented in a desired direction. The assembly further includes spacer means connected to the support frame movement mechanism for spacing the support frame and the engine from the outer envelope of the hull so as to create sufficient clearance therebetween when the support frame is moved. Also provided, is a mounting framework for attaching the spacer means to the hull.

In another feature, the propulsion and steering assembly further includes a propeller operatively connected to the engine. The propeller is selected from the group consisting of a push-type propeller and a pull-type propeller.

In yet another feature, the support frame movement mechanism includes a dual hinge assembly. The support frame movement mechanism includes a first actuator for imparting rotary movement to the support frame about a first axis of rotation and a second actuator for imparting rotary movement to the support frame about a second axis of rotation. The first axis of rotation is perpendicular to the second axis of rotation. In one feature, the support frame depends from the second rotary actuator. The second actuator is carried by the first rotary actuator and the first rotary actuator is mounted to the spacer means. In an alternative feature, the support frame depends from the first rotary actuator. The first rotary actuator is carried by the second rotary actuator and the second rotary actuator is mounted to the spacer means.

In a further feature, the first and second rotary actuators are hydraulic actuators. In an alternative feature, the first and second rotary actuators are selected from the group consisting of pneumatic actuators and electric actuators.

In another feature, the first actuator is operable to pivot the support frame and the engine between a first lateral limit position and a second lateral limit position. An angle is defined between the first and second lateral limit positions. In one feature, the angle is less than or equal to approximately 180.

In yet another feature, the second actuator is operable to pivot the support frame and the engine between an upper limit position and a lower limit position. An angle is defined between the upper and lower limit positions. In one feature, the angle is less than or equal to approximately 180.

In another feature, the support frame movement mechanism is further provided with means for restricting movement of the support frame between the first and second lateral limit positions, and between the upper and lower limit positions.

In yet another feature, the spacer means includes an elongate structural member supported from the mounting framework in a cantilevered fashion.

In a further feature, the mounting framework is curved convexly to closely correspond to the radius of curvature of the hull to encourage close contact therebetween and facilitate attachment of the mounting framework to the hull.

In accordance with another broad embodiment of the present invention, there is provided an airship. The airship possesses a hull having an outer envelope and a propulsion and steering system operatively connected to the outer envelope of the hull. The system includes at least one propulsion and steering assembly. The at least one propulsion and steering assembly includes an engine for producing thrust to propel the airship and a support frame for carrying the engine. The engine is fixed to the support frame. A support frame movement mechanism is operable to move the support frame relative to the hull to thereby allow the engine and the thrust produced by the engine to be oriented in a desired direction. The at least one assembly further includes spacer means connected to the support frame movement mechanism for spacing the support frame and the engine from the outer envelope of the hull so as to create sufficient clearance therebetween when the support frame is moved. Also provided, is a mounting framework for attaching the spacer means to the hull.

In one feature, the hull is an elongated body and includes a first conical end portion, a second end conical portion and a cylindrical intermediate portion extending between the first and second conical portions. The intermediate portion has a sidewall. The at least one propulsion and steering assembly includes a first propulsion and steering assembly and a second propulsion and steering assembly. The first and second propulsion and steering assemblies are mounted to the sidewall of the intermediate portion in opposition to each other.

In a further feature, the at least one propulsion and steering assembly also includes a third propulsion and steering assembly and a fourth propulsion and steering assembly. The third and fourth propulsion and steering assemblies are mounted to the sidewall of the intermediate portion in opposition to each other. The first and second propulsion and steering assemblies define a fore pair of steering and propulsion assemblies, and the third and fourth propulsion and steering assemblies define an aft pair of steering and propulsion assemblies. The fore pair of steering and propulsion assemblies is disposed on a first plane, and the aft pair of steering and propulsion assemblies is disposed on a second plane. In one feature, the first plane is the same as the second plane. In an alternative feature, the first plane is different than the second plane.

In an additional feature, the fore pair of steering and propulsion assemblies is mounted to the intermediate portion adjacent the first conical end portion, and the aft pair of steering and propulsion assemblies is mounted to the intermediate portion adjacent the second conical end portion.

In still another feature, the hull of the airship is spherical.

In accordance with yet another broad embodiment of the present invention, there is provided a kit for a steering and propulsion assembly or use with an airship. The airship possesses a hull having an outer envelope. The assembly is mountable to the outer envelope of the hull. The kit includes an engine for producing thrust to propel the airship and a support frame for carrying the engine. The engine is fixable to the support frame. A support frame movement mechanism is operable to move the support frame relative to the hull to thereby allow the engine and the thrust produced by the engine to be oriented in a desired direction. The kit further includes spacer means connectable to the support frame movement mechanism for spacing the support frame and the engine from the outer envelope of the hull so as to create sufficient clearance therebetween when the support frame is moved. Also provided, is a mounting framework connectable to the spacer means and fixable to the hull.

In accordance with still another broad embodiment of the present invention, there is provided a method of steering and propelling an airship. The method includes the steps of providing an airship. The airship includes a hull having an outer envelope. Also provided is a propulsion and steering system operatively connected to the outer envelope of the hull. The system includes at least one propulsion and steering assembly. The at least one propulsion and steering assembly includes an engine for producing thrust to propel the airship and a support frame for carrying the engine. The engine is fixed to the support frame. A support frame movement mechanism is operable to move the support frame relative to the hull to thereby allow the engine and the thrust produced by the engine to be oriented in a desired direction. The at least one assembly further includes spacer means connected to the support frame movement mechanism for spacing the support frame and the engine from the outer envelope of the hull so as to create sufficient clearance therebetween when the support frame is moved. A mounting framework is provided for attaching the spacer means to the hull. The method further includes the steps of actuating the engine to produce thrust and actuating the support frame movement mechanism to urge the support frame to move relative to the hull. The thrust produced by the engine is oriented in a direction opposite to the desired direction of travel and the airship is steered in the desired direction of travel.

### BRIEF DESCRIPTION OF THE DRAWINGS

The embodiments of the present invention shall be more clearly understood with reference to the following detailed description of the embodiments of the invention taken in conjunction with the accompanying drawings, in which:

FIG. 1 is a front left perspective view of an airship provided with a propulsion and steering system according to an embodiment of the present invention, the propulsion and steering system including four propulsion and steering assemblies, each of the assemblies being disposed in an outward orientation or intermediate position;

FIG. 2 is a top plan view of the airship shown in FIG. 1;

FIG. 3 is a front end view of the airship shown in FIG. 1;

FIG. 4 is a front left perspective view of one of the propulsion and steering assemblies shown in FIG. 1;

FIG. 5 is a front right perspective view of the support frame and support frame movement mechanism shown in FIG. 4;

FIG. 6 is a rear right perspective view of the support frame and support frame movement mechanism shown in FIG. 5;

FIG. 7 is a top plan view of the support frame and support frame movement mechanism shown in FIG. 5;

FIG. 8 is a left elevation view of the support frame and support frame movement mechanism shown in FIG. 5;

FIG. 9 is an enlarged, isolated, bottom plan view of the propulsion and steering assembly illustrated in FIG. 4 showing the support frame movement restricting means, and the support frame occupying an outward orientation or intermediate position, the engine block and propeller having been omitted for clarity;

FIG. 10 is a cross-sectional view of the support frame movement restricting assembly illustrated in FIG. 9, taken along the cross-section line “9-9”;

FIG. 11 is an enlarged partial, front end view of the airship illustrated in FIG. 1, showing in solid lines the support frame pivoted upwardly to its upper limit position and showing in dashed lines the support frame pivoted downwardly to its lower limit position;

FIG. 12 is a cross-sectional view of the propulsion and steering assembly similar to that illustrated in FIG. 9 except that the support frame is shown pivoted downwardly to its lower limit position;

FIG. 13 is a cross-sectional view of the propulsion and steering assembly similar to that illustrated in FIG. 9 except that the support frame is shown pivoted upwardly to its upper limit position;

FIG. 14 is an enlarged partial, top plan view of the propulsion and steering assembly illustrated in FIG. 1, showing in solid lines the support frame pivoted to its fore limit position and showing in dashed lines the support frame pivoted to its aft limit position;

FIG. 15 is a view of the propulsion and steering assembly similar to that shown in FIG. 9, except that the support frame is shown pivoted to its aft limit position;

FIG. 16 is a top plan view of an alternative embodiment of the airship illustrated in FIG. 1, showing the support frames of the first, second, third and fourth propulsion and steering assemblies all pivoted to their respective aft limit positions and thrust being generated by each of the assemblies to propel the airship in the forward direction from an initial position shown in dashed lines to an end position shown in solid lines;

FIG. 17 is another top plan view of the airship illustrated in FIG. 16, showing the support frames of the first, third and fourth propulsion and steering assemblies all pivoted to their respective aft limit positions, the support frame of the second propulsion and steering assembly occupying its intermediate position and thrust being generated by each of the assemblies to propel the airship forwardly and laterally from an initial position shown in dashed lines to an end position shown in solid lines;

FIG. 18 is a front end elevation view of the airship shown in FIG. 16, with the support frames of the first, second, third and fourth propulsion and steering assemblies all pivoted to their respective upper limit positions and thrust being generated by each of the assemblies to propel the airship downwardly from an initial position shown in dashed lines to an end position shown in solid lines; and

FIG. 19 is a side elevation view of the airship shown in FIG. 16, with the support frames of the fore pair of propulsion and steering assemblies pivoted to their respective upper limit positions, the support frames of the aft pair of propulsion and steering assemblies pivoted to their respective aft limit positions and thrust being generated by each of the assemblies to propel the airship downwardly and forwardly from an initial position shown in dashed lines to an end position shown in solid lines, to effect a descent maneuver.

### DETAILED DESCRIPTION OF EMBODIMENTS OF THE INVENTION

The description which follows, and the embodiments described therein are provided by way of illustration of an example, or examples of particular embodiments of principles and aspects of the present invention. These examples are provided for the purposes of explanation and not of limitation, of those principles of the invention. In the description that follows, like parts are marked throughout the specification and the drawings with the same respective reference numerals.

In the description and drawings herein, and unless noted otherwise, the terms “vertical”, “lateral” and “horizontal”, are references to a Cartesian co-ordinate system in which the vertical direction generally extends in an “up and down” orientation from bottom to top (z-axis) while the lateral direction generally extends in a “left to right” or “side to side” orientation (y-axis). In addition, the horizontal direction extends in a “front to back” orientation and can extend in an orientation that may extend out from or into the page (x-axis). The force of gravity, and hence buoyancy, acts parallel to the z-axis.

As used in the specification, there are also defined three axes of rotation with respect to airships based on the center of gravity of the airship. Typically, the orientation of an airship can be defined by the amount of rotation of the parts of the airship along these three axes. Each axis of this coordinate system is perpendicular to the other two axes. For example, the pitch axis is perpendicular to the yaw axis and the roll axis. A pitch motion or “pitch” is an up or down movement of the nose and tail of the aircraft along the z-axis. A yaw motion or “yaw” is a movement of the nose of the aircraft from side to side along the y-axis. In other words, if an aircraft model placed on a flat surface is spun or pivoted around its center of mass, it would be described as yawing. A roll motion or “roll” is a rotational movement of an airship along the x-axis. If the airship is thought of as having a vertical, or z-axis, a longitudinal, or x-axis, and a transverse, or y-axis, pitch is rotation about the y-axis, roll is rotation about the x-axis, and yawing is rotation about the z-axis. When described together, the orientation of an airship is typically referred to as “attitude”.

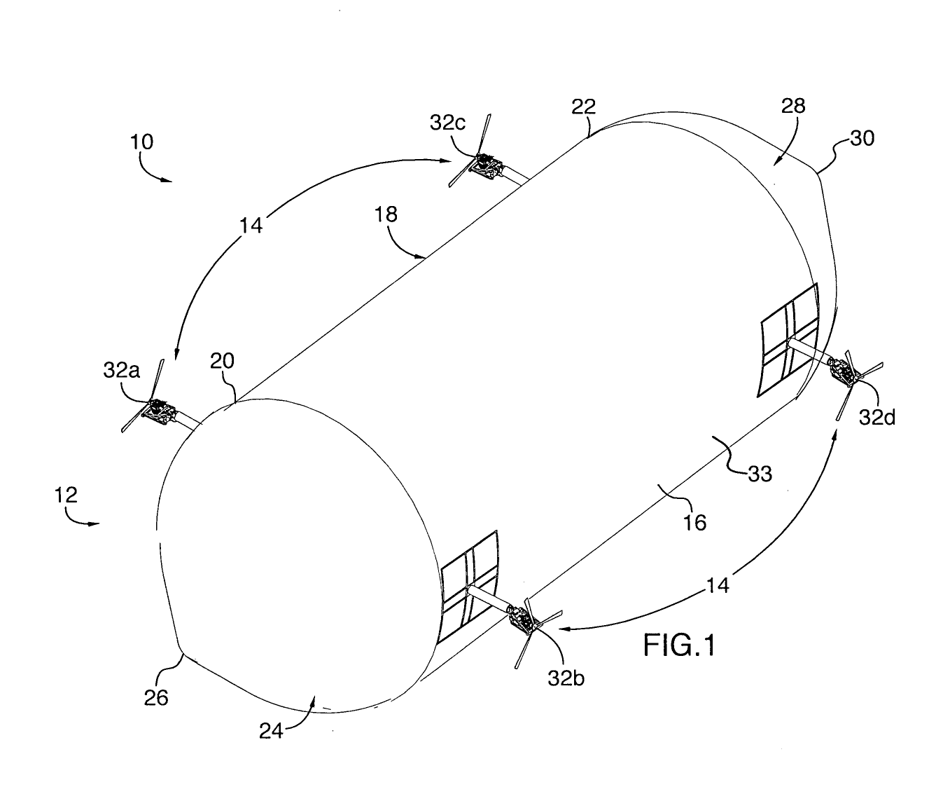

Referring to FIGS. 1 to 3, there is shown an airship designated generally with reference numeral 10. The airship 10 has a hull 12 and a propulsion and steering system 14 securely mounted to the hull 12. The hull 12 includes an outer envelope 16 which is adapted to contain a certain amount of a lifting gas which provides buoyancy to the airship 10. The outer envelope 16 is manufactured from an airtight material and may be formed from panels that are joined together so as to be air impermeable, such as by heat welding, sewing, or any other joining techniques known to those skilled in the art.

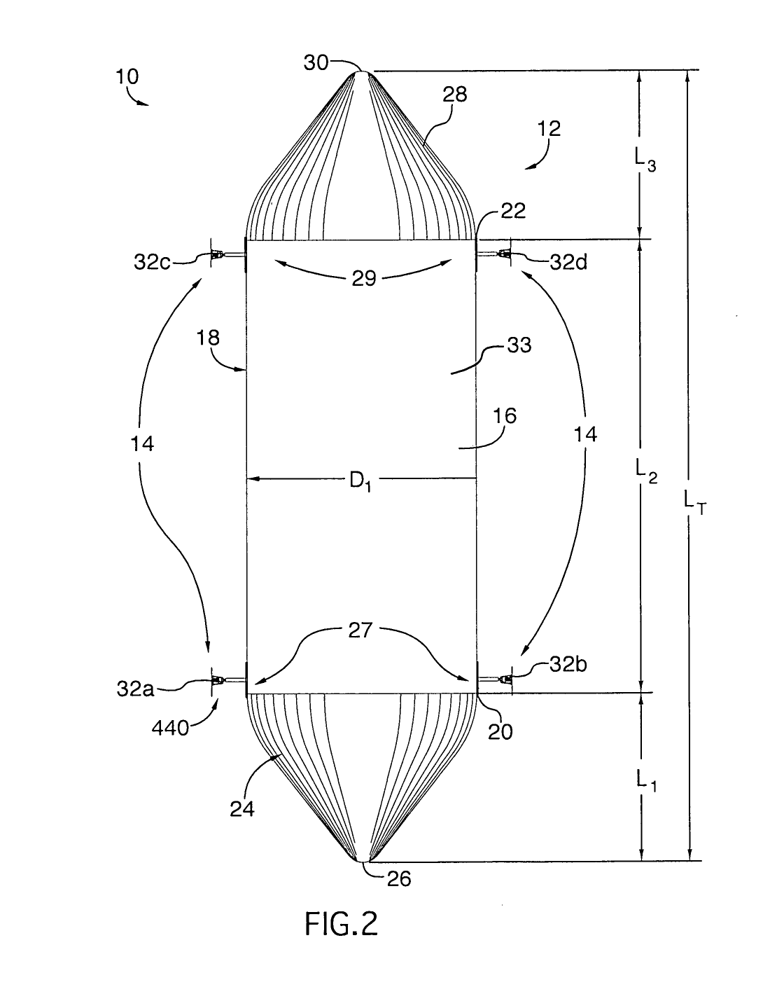

As best shown in FIG. 2, the hull 12 has a generally elongated ellipsoidal (or cigar) shape defined by a fore conical end portion 24, an aft conical end portion 28 and a generally cylindrical intermediate portion 18 extending between the fore and aft conical end portions 24 and 28. The intermediate portion 18 meets the fore conical end portion 24 along a first margin 20 and the aft conical end portion 28 along a second margin 22. Each conical end portion 24, 28 extends outwardly and away from each respective margin 20, 22, in a tapering fashion to ultimately, terminate at an apex 26, 30, respectively.

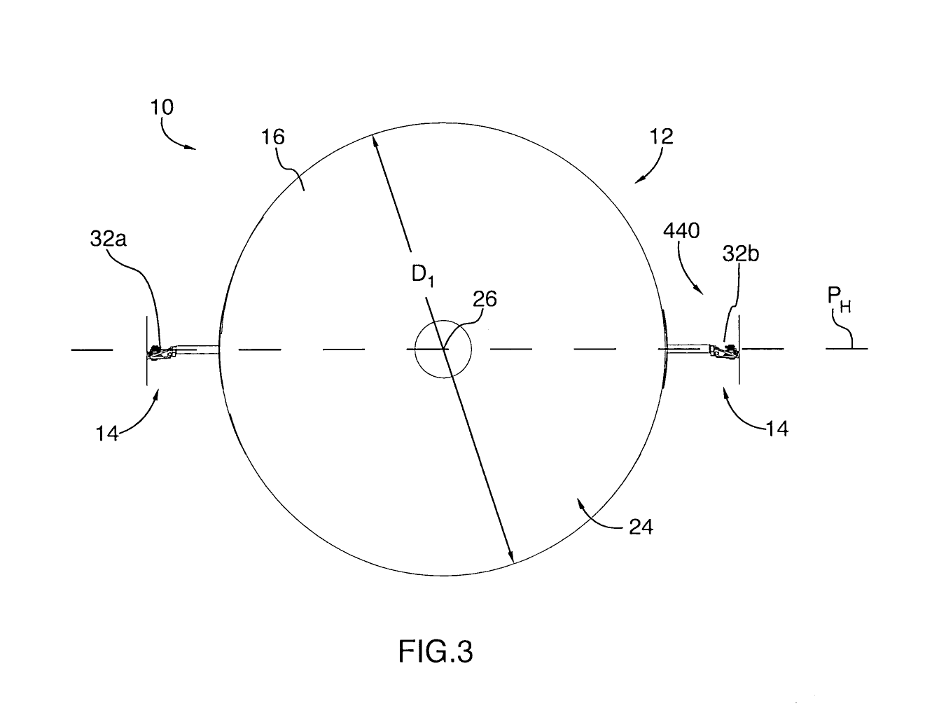

The hull 12 has a total length L_{T} which corresponds to the distance between the apexes 26 and 30 (as shown in FIG. 2); a length L₁ which corresponds to the distance between the apex 26 of the fore conical end portion 24 and the first margin 20; a length L₂ which corresponds to the distance between the first and second margins 20 and 22; a length L₃ which corresponds to the distance between the second margin 22 and the apex 30 of the aft conical end portion 28; and a diameter D₁ which corresponds to the diameter of the intermediate portion 18 (as shown in FIG. 3). In this embodiment, the length L_{T} measures 235 ft.; the length L₁ measures 50 ft; the length L₂ measures 135 ft.; the length L₃ measures 50; and the diameter D₁ measures 65 ft. In alternative embodiments, the hull 12 could be sized differently. For instance, the dimensions L_{T}, L₁, L₂, L₃ and D₁ could be increased or decreased. In still other embodiments, the hull 12 could be formed with a different shape altogether. For example, the hull could be egg-shaped, cylindrical or spherical, or have any other shape suitable for the desired application.

The airship 10 may further include a gondola (not shown) attached to the hull 12 or, alternatively, positioned within the interior of the hull 12. The gondola can be used to carry passengers or a payload, such as, for example, electromagnetic interface apparatus, communication equipment, surveillance equipment, radars or spectral imaging equipment, or equipment for controlling the propulsion and steering system 14.

In the embodiment shown in FIGS. 1 and 2, the propulsion and steering system 14 includes two pairs of propulsion and steering assemblies identified generically with reference numeral 32—a fore pair 27 of assemblies 32a and 32b and an aft pair 29 of assemblies 32c and 32d—mounted to the sidewall 33 of the intermediate portion 18. The fore pair 27 of assemblies 32a and 32b is disposed adjacent the first margin 20, while the aft pair of assemblies 32c and 32d is disposed adjacent the second margin 22. In other embodiments, both the fore and aft pairs 27 and 29 could be disposed at different location along the hull 12.

The assembly 32a of the fore pair 27 and the assembly 32c of the aft pair 29 are circumferentially aligned with each other (that is, in the view shown in FIG. 3, if assembly 32a were projected onto assembly 32c, these assemblies would occupy the same circumferential position on the intermediate portion 18). Similarly, the assemblies 32b and 32d are also circumferentially aligned with each other. The assemblies 32a and 32b of the fore pair 27 are positioned to be diametrically opposed to each other. In like fashion, the assemblies 32c and 32d of the aft pair 29 are positioned to be diametrically opposed to each other.

In this embodiment, all the assemblies 32a, 32b, 32c and 32d lie in the same generally horizontal plane P_{H} which cuts through the center of the intermediate portion 18. In other embodiments, the arrangement of the assemblies could be different. For instance, each assembly could be circumferentially staggered from the immediately adjacent assemblies as desired, such that two opposed, first and second assemblies lie in the same plane and two opposed, third and fourth assemblies lie in a different plane. In a specific example of such an embodiment, each assembly could be circumferentially staggered from the immediately adjacent assemblies by 90 degrees, such that two first and second assemblies are disposed on the plane P_{H} and the third and fourth assemblies are disposed on a plane perpendicular to the plane P_{H}.

It should be appreciated that in other embodiments the propulsion and steering system could include a greater or lesser number of propulsion and steering assemblies disposed in alternate configurations along the hull. For instance, for smaller cigar-shaped airships or for spherical it may be sufficient to have a single pair of opposed propulsion and steering assemblies.

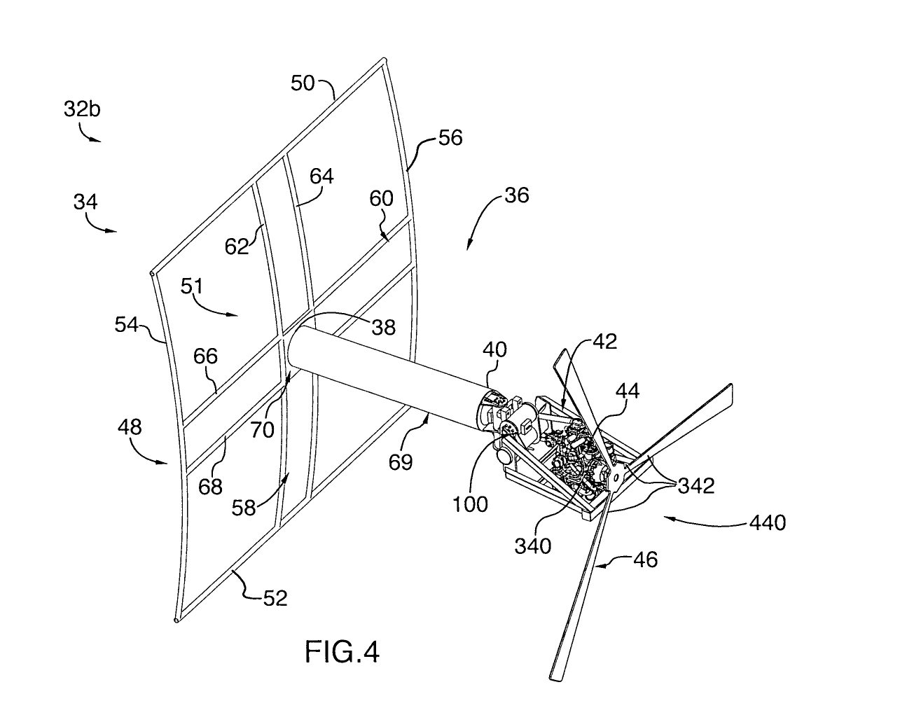

The propulsion and steering assemblies 32a, 32b, 32c, 32d all have the same general structure such that the description of one representative assembly—assembly 32b—will suffice to enable a person skilled in the art to appreciate the details and workings of all the assemblies 32a, 32b, 32c, 32d. With reference to FIG. 4, the assembly 32b will now be described in greater detail. The propulsion and steering assembly 32b includes: an engine block 44 for driving rotation of a propeller 46; a support frame 42 for carrying the engine block 44; a mechanism 100 for moving the support frame 42 relative to hull 12 to thereby allow the orientation of the engine block 44 and propeller 46 to be adjusted; spacer means 36 connected to the support frame 42 for spacing the support frame 42, the engine block 44 and the propeller 46 from the hull 12; and a mounting framework 34 for fixing the spacer means 36 to the hull 12. As will be explained in greater detail below, when the propeller 46 is driven to rotate by the engine block 44, thrust is produced to propel the airship 10. Actuation of the support frame movement mechanism 100 allows the thrust thus produced to be oriented in a desired direction to thereby steer the airship.

The mounting framework 34 has an outer, square-shaped, frame portion 48 and an inner, cross-shaped, tubular portion 51 attached to the outer frame portion 48. The outer frame portion 48 is defined by a pair of opposed, first and second horizontal frame members 50 and 52, and a pair of opposed, third and vertical fourth frame members 54 and 56 joining the first frame member 50 to the second frame member 52. In this embodiment, each of the frame members 50, 52, 54 and 56 is a tubular structural member made of aircraft-grade aluminum, and measures 10 ft. In other embodiments, the mounting framework 34 could be shaped or sized differently and could be manufactured from other suitable materials, for example, from composites.

The inner frame portion 51 includes first and second arm portions 58 and 60 arranged perpendicular to each other to define the cross shape of the inner frame portion 51. The first arm portion 58 extends vertically between, and is joined to, the first and second horizontal frame member 50 and 52, while the second arm portion 60 runs horizontally between, and is connected to, the third and fourth vertical frame members 54 and 56. The first and second arm portions 58 and 60 intersect at, and are fixed to each other by, a centrally disposed square plate 70. To reduce the weight of the mounting framework 34 while still providing the requisite structural rigidity, each of the arm portions 58 and 60 is built up from two spaced apart, tubular members 62 and 64 (in the case of arm portion 58) and 66 and 68 (in the case of arm portion 60) fastened to the plate 70. In like fashion to the frame members 50, 52, 54 and 56, the tubular members 62, 64, 66 and 68 and the plate 70 are also fabricated from aircraft-grade aluminum. In an alternative embodiment, the complete mounting framework 34 could be manufactured from other suitable materials, for example, composites.

As best shown in FIGS. 3 and 4, the third and vertical fourth frame members 54 and 56 of the outer frame portion 48 and the first arm portion 58 of the inner frame portion 51 are bowed or curved convexly to closely correspond to the radius of curvature of the intermediate portion 18 of the hull 12. This configuration tends to facilitate attachment of the mounting framework 34 to the hull 12 by encouraging close contact between the tubular members of the mounting framework 34 and the outer envelope 16 of the hull 12. In this regard, the mounting framework 34 is secured to the hull 12 using a plurality of lightweight flexible sleeves (not shown) sewn to the outer envelope 16. A portion of these sleeves is wrapped around the tubular members 50, 52, 54, 56, 58, 64, 66 and 68 and secured in place by hook and loop fasteners. A plurality of cables (not shown) fixed to the outer envelope 16 also serve to secure the mounting framework to the hull. It will thus be appreciated that as configured the attachment framework 34 provides multiple attachment sites for the sleeves and in this manner tends to distribute the forces acting on the outer envelope 16 of the hull 12.

In other embodiments, the mounting framework could be configured differently. Instead of being built up of welded tubular members, it could be constructed of other hollow structural members assembled using fasteners or other suitable assembly techniques. Moreover, the framework could be shaped differently. For instance, it could have a generally rectangular shape, or alternatively, it could be made circular (this shape would particularly well-suited for use with an airship having a spherical hull). Other shapes could be employed to similar advantage. Additionally, while the use of sleeves is the preferred means of fastening the mounting framework to the hull, it should be appreciated that this need not be the case in every application. In other embodiments, the mounting framework could be attached to the hull using cables attached to one or more catenary curtains suspended from an internal portion of the outer envelope. Other attachment means could also be used, for example, straps or webbings. In the further alternative, the mounting framework could be attached to an internal frame of the hull.

Still referring to FIG. 4, in this embodiment, the spacer means 36 takes the form of an elongate hollow structural member 69 supported in a cantilevered fashion from the mounting framework 34. The structural member 69 has a first end 38 fastened to the plate 70, a second end 40 fixedly connected to a portion of the support frame movement mechanism 100 and an internal cavity (not shown) defined therein between the first and second ends 38 and 40. The presence of an internal cavity within the structural member 69 helps reduce the overall weight of the propulsion and steering assembly. Additionally, the internal cavity may be employed to accommodate various equipment, for instance, one or more of hydraulic pumps, hydraulic fluid lines, batteries or fuel cells, thereby shielding such components from the elements.

The spacer means 36 serves a dual purpose—it carries the support frame 42 and connects the support frame 42 to the hull 12 and in addition, it creates sufficient clearance to prevent the outer envelope 16 of the hull 12 from being damaged by the propeller 46, the engine block 44 or the support frame 42, when the first portion 47 of the support frame 42 is urged to move. In this embodiment, the structural member 69 is tubular. Its length and diameter are selected to resist bending and provide sufficient strength to support the support frame 42 and the engine block 44 (and propeller 46) mounted thereon. In this embodiment, the diameter of the structural member 69 measures 1 ft. In respect of the length, because of the structural member's spacing function, its tends also to be correlated to the diameter of the propeller 46. In this embodiment, the length of the structural member measures 6 ft. and the diameter of the propeller 46 is 10 ft. It should however be understood that the diameter of the propeller 46 is chosen for its ability to produce a desired amount of thrust and the length of the structural member 69 will be selected to create sufficient clearance for that size propeller. Of course, the diameter of the propeller 46, and therefore the length of the structural member 69, could be adjusted to suit a particular application. Other changes to the structural member are also possible. For instance, in other embodiments, the hollow structural member could be sized with a larger or smaller diameter. In still other embodiments, it could be shaped differently. The hollow structural member could have a square or rectangular cross-section.

While it is generally preferred that the spacer means 36 be a unitary hollow structural member, this need not be the case in every application. In alternative embodiments, the spacer means could be a structural beam (e.g. an I-beam) or further still it could be a built-up structure made of welded or otherwise fastened members.

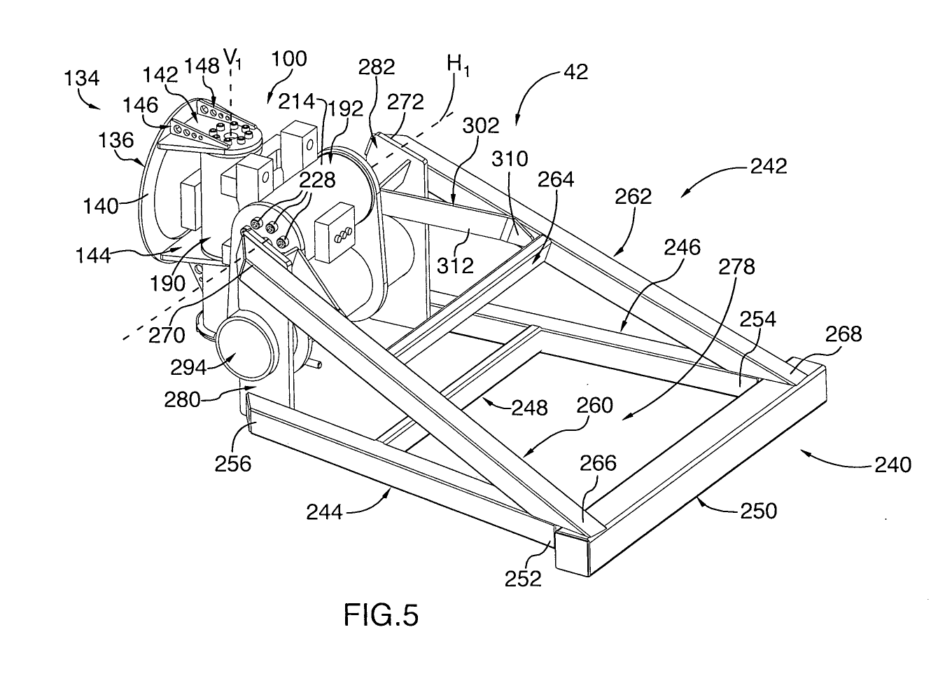

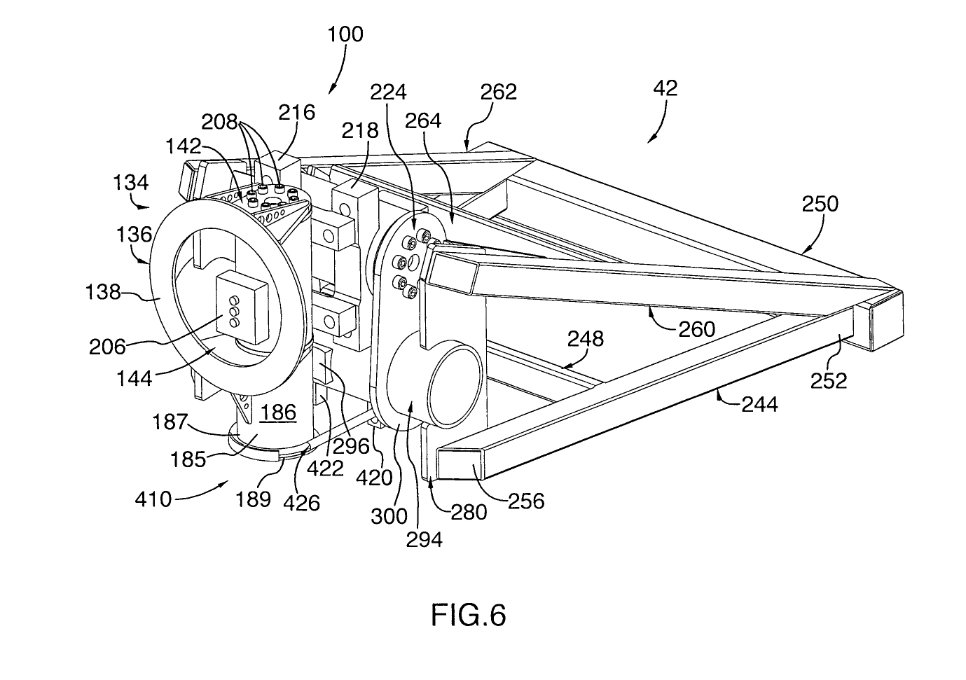

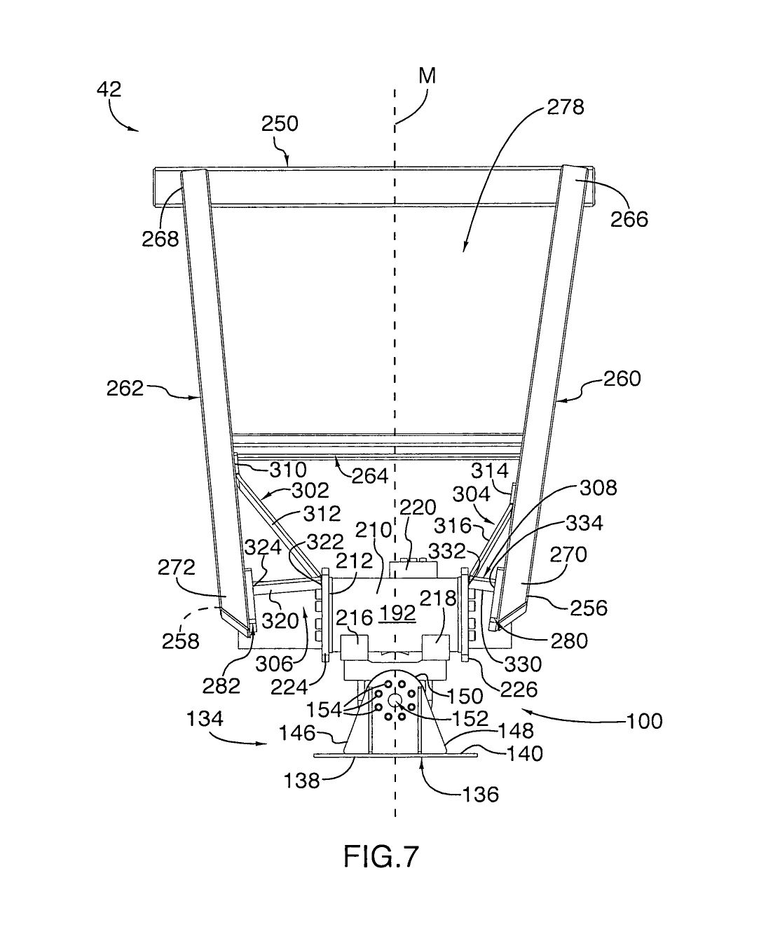

The support frame movement mechanism 100 is connected to the spacer means 36 by a connecting bracket 134. The connecting bracket 134 comprises an annular plate 136 sized to correspond generally to the diameter of the hollow structural member 69. The annular plate 136 has a first face 138 (as best shown in FIG. 6) secured to the second end 40 of the hollow structural member 69 by welding or other fastening means, and a second face 140 (as best shown in FIG. 5) opposite the first face 138. Projecting perpendicularly from the second face 140 is a pair of spaced apart, upper and lower arms 142 and 144. Each arm 142, 144 has a generally triangular shape defined by lateral edges 146 and 148 converging towards a rounded apex 150 (as best shown in FIG. 7). Proximate the round apex 150, a relatively large bore 152 is defined in each arm 142 and 144. The bore 152 receives a large bolt (not shown) to resist the shear forces acting on the arms 142 and 144. The bore 152 in each arm 142, 144 is surrounded by a number of smaller openings 154 (in this embodiment, eight openings) disposed in a ring pattern about the bore 152. As will be explained in greater detail below, these openings 154 accommodate fasteners for attaching a portion of the support frame movement mechanism 100 to the connecting bracket 134.

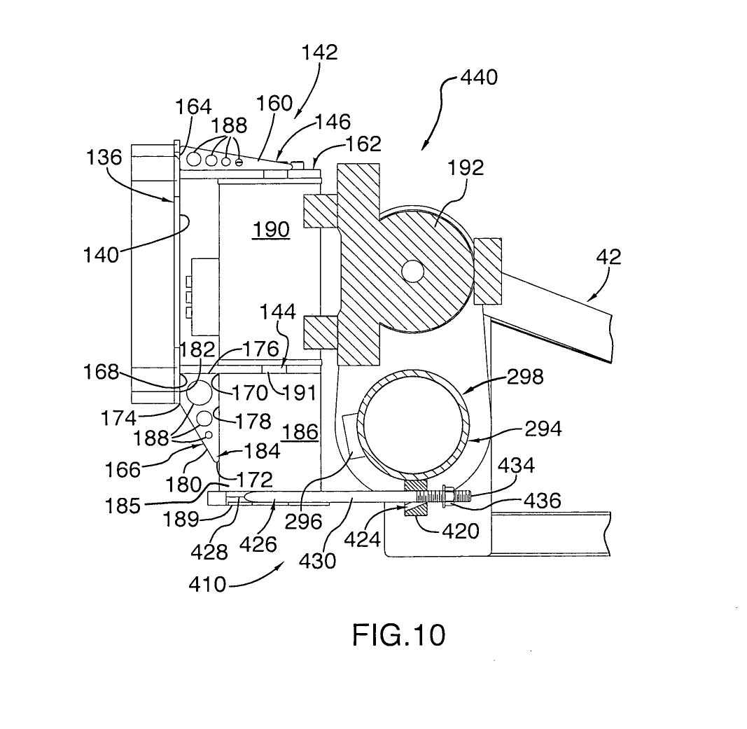

With specific reference to FIG. 10, the upper arm 142 is reinforced with triangular gusset plates 146 and 148 welded along their respective lower horizontal edges 160 to the top surface 162 of the upper arm 142, and along their respective vertical edges 164 to the second face 140 of the annular plate 136. The lower arm 144 is reinforced with a single gusset plate 166. The gusset plate 166 is formed with four corners 168, 170, 172 and 174, its shape being defined by a first horizontal edge 176 extending between corners 168 and 170; a second, relatively long, vertical edge 178 extending between corners 170 and 172; a third angled edge 180 running between corners 172 and 174; and a fourth, relatively short, vertical edge 182 running between corners 174 and 168. The second and third edges 178 and 180 cooperate with each other define a wedge-like portion 184. The first horizontal edge 176 is welded to the bottom face 191 of the lower arm 144, the second vertical edge 178 is welded to the sidewall 185 of the tubular post member 186, and the fourth vertical edge 182 is welded to the second face 140 of the annular plate 136. Each of the gusset plates 146, 148 and 166 is formed with a plurality of weight reducing perforations 188.

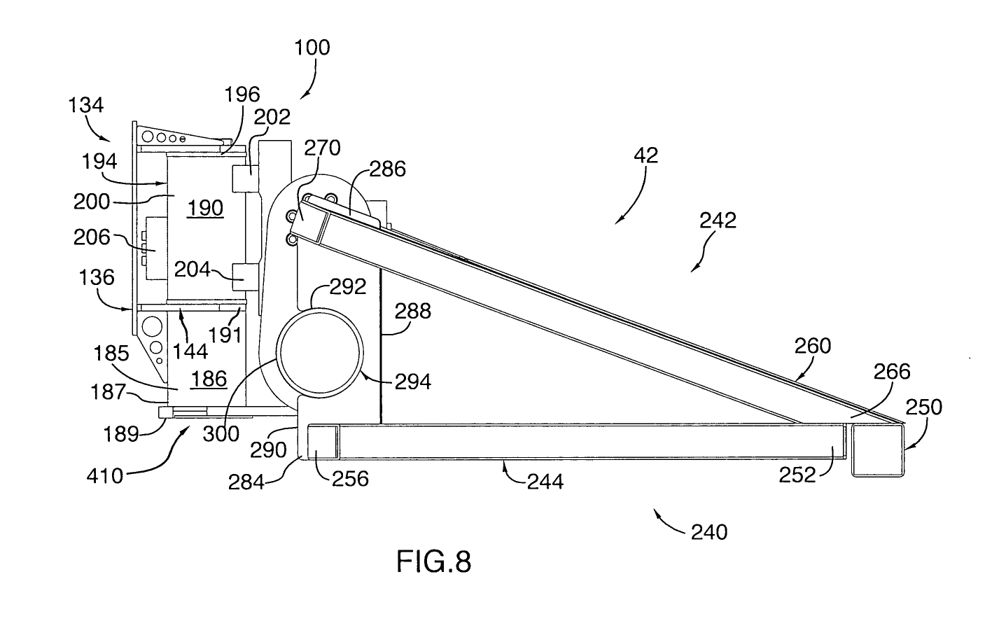

As shown in FIGS. 6 and 8, the tubular post member 186 is welded to the lower face 191 of the arm 144 and extends downwardly therefrom. At its bottom end 187, the tubular post member 186 is formed with a flange 189 projecting radially outward from the sidewall 185. As will be made clear below, the tubular post member 186 (and more specifically, the flange 189) define part of the support frame movement restricting means 410.

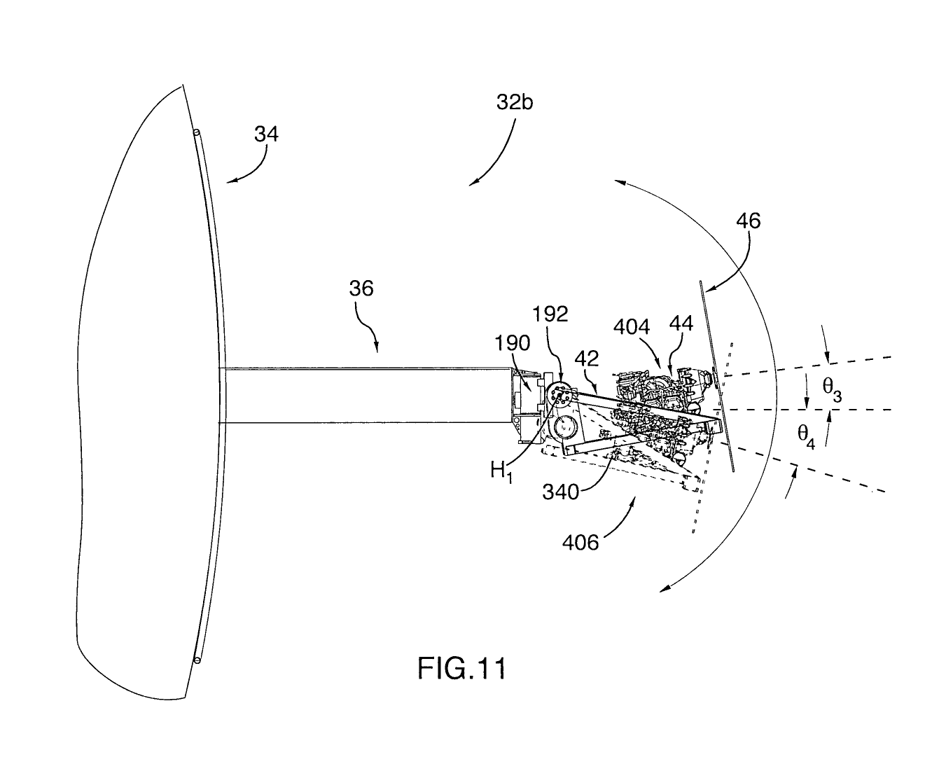

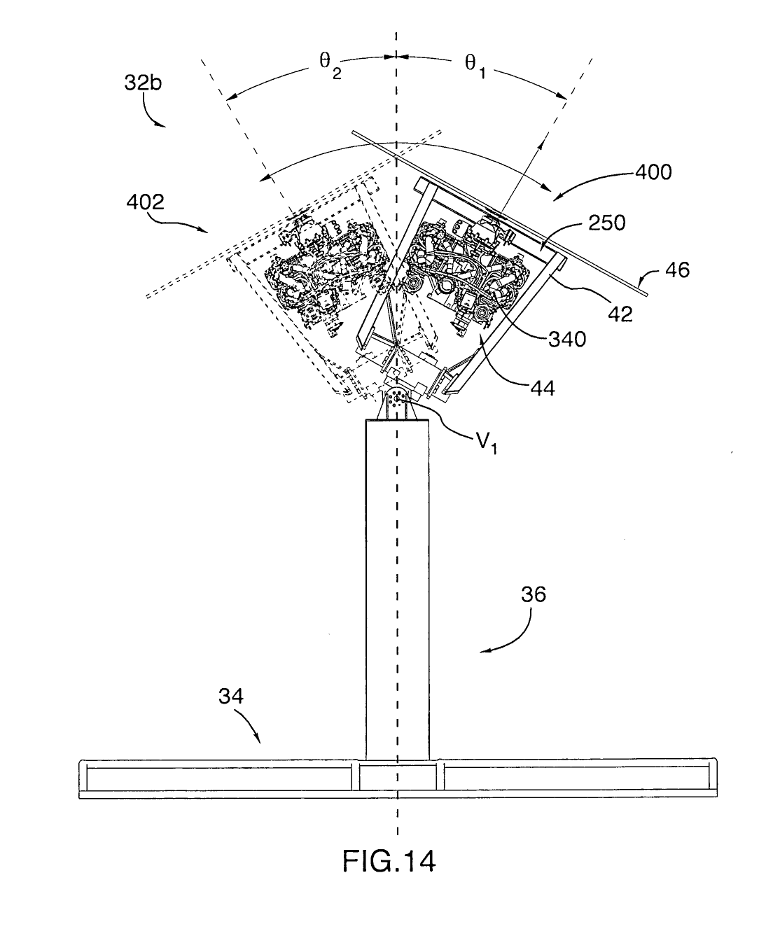

The support frame movement mechanism 100 is now described in greater detail with reference to FIGS. 5 to 8. Preferably, the mechanism 100 employs a dual hinge design which is embodied in a first actuator 190 for imparting rotary movement to the support frame 42 about a first axis of rotation V₁, and a second actuator 192 for imparting rotary movement to the support frame 42 about a second axis of rotation H₁ perpendicular to the first axis of rotation V₁. The first actuator 190 is operable to pivot the support frame 42 (and the engine block 44 and propeller 46) between a first fore limit position 400 and a second aft limit position 402 (as best shown in FIG. 14). Similarly, the second actuator 192 is operable to upwardly or downwardly tilt or pivot the support frame 42 (and the engine block 44 and propeller 46) between an upper limit position 404 and a lower limit position 406 (as best shown in FIG. 11). The mechanism 100 is further provided with means 410 for restricting movement of the support frame 42 within a desired range of movements bound by the first and second limit positions 400 and 402, and the upper and lower limit positions 404 and 406.

In this embodiment, the first rotary actuator 190 is mounted to the annular plate 136 and carries the second rotary actuator 192, and the support frame 42 depends from the second rotary actuator 192. This need not be the case in every application. In other embodiments, the arrangement of actuators may be reversed with the second rotary actuator attached to the annular plate and carrying the first rotary actuator, while the support frame hangs from the first rotary actuator.

Preferably, the first and second rotary actuators are hydraulic actuators, as these types of actuators tend to be responsive, precise and powerful, and capable of generating significant amounts of torque. Conceivably though, other types of actuators could also be used, for example, pneumatic or electric actuators.

In this embodiment, the first rotary actuator 190 is a hydraulic rotary actuator manufactured by Helac Corporation® (Enumclaw, Wash., U.S.A.) and sold under the L-20 Series™ brand name. As the structure and workings of this type of actuator are well-known in the art, only a very brief, high-level, description of the first rotary actuator 190 will be provided. The first rotary actuator 190 has an external body 194 and a rotary assembly (not shown) housed within the body 194. The body 194 is defined by a generally cylindrical sleeve portion 200 and a pair of spaced apart, upper and lower mounting cross-members (or feet) 202 and 204 welded to the sleeve portion 200 transverse to its longitudinal axis. As will be apparent from the description that follows, the cross-members 202 and 204 serve to attach the first rotary actuator 190 to the second rotary actuator 192.

A port block 206 is mounted to the sleeve portion 200 at a location opposite the cross-members 202 and 204 facing the annular plate 136. The port block 206 houses a plurality of ports which allow hydraulic fluid to flow into (or out of) the first rotary actuator 190 and a plurality of valves for regulating flow of hydraulic fluid and the pressure within the rotary assembly. Although not shown, hydraulic feed lines operatively connected to a hydraulic pump and an actuator controller are provided to deliver (or remove) hydraulic fluid to (or from) the ports.

The rotary assembly includes upper and lower rotary elements (not shown). The sleeve portion 200 is rotatable relative to the upper and lower rotary elements, such that when the first actuator assembly 190 is actuated, it is the sleeve portion 200 which will be permitted to pivot or rotate about the first rotational axis V₁. The top face of the upper rotary element and bottom face of the lower rotary element each have a plurality of openings (not shown) similar in size and layout to the openings 154 defined in the upper and lower arms 142 and 144. The openings in the top face of the upper rotary element are alignable with the openings 154 in the upper arm 142 to permit the insertion of fasteners 208 therethrough to secure the upper rotary element to the upper arm 142. Likewise, the openings in the bottom face of the lower rotary element are alignable with the openings 154 in the lower arm 144 to allow fasteners (not shown) to be inserted therethrough to secure the lower rotary element to the lower arm 144.

It will be appreciated that the first rotary actuator 190 in combination with the upper and lower arms 142 and 144 defines a vertical hinge operable to permit the support frame 42 to pivot about the first axis of rotation V₁. When the first rotary actuator 190 is actuated, the action of the pressurized hydraulic fluid within the rotary assembly urges the sleeve portion 200 to pivot relative to the rotary elements which are fixed to the mounting arms 142 and 144. This rotary motion is transferred to the support frame 42 (and ultimately, to the drive block 42 and propeller 46) through the second rotary actuator 192.

The second rotary actuator 192 is generally similar to the first rotary actuator 190, in that it too has an external body 210 which houses a rotary assembly (not shown). However, in contrast to the body 194 which has a vertical orientation, the body 210 extends horizontally. The body 210 is defined by a generally cylindrical sleeve portion 214 and a pair of spaced apart, first and second lateral mounting cross-members (or feet) 216 and 218 welded to the sleeve portion 214 transverse to its longitudinal axis. The cross-members 216 and 218 are bolted onto the cross-members 202 and 204. While bolting is the preferred means of fastening the cross-member 216 and 218 to the cross-members 202 and 204, in other embodiments, the cross-members could be releasably attached using other known means. Alternatively, the cross-members could be secured to each other with a permanent connection (e.g. by welding).

The second rotary actuator 192 also possesses a port block 220 having a plurality of ports (not shown) and valves (not shown), similar to port block 206. The port block 220 is mounted to the sleeve portion 214 at a location opposite the cross-members 216 and 218. Although not shown, hydraulic feed lines operatively connected to a hydraulic pump and an actuator controller are provided to deliver (or remove) hydraulic fluid to (or from) the ports of the port block 220.

The rotary assembly of the second rotary actuator 192 resembles the rotary assembly of the first rotary actuator 190 described above in that it includes first and second rotary elements (not shown). The first and second rotary elements are rotatable relative to the sleeve portion 214 and are configured for coordinated co-rotation. Contrary to the first actuator assembly 190 where the upper and lower rotary elements remain fixed and the sleeve portion 200 is permitted to pivot or rotate, in the second actuator assembly 192 it is the first and second rotary elements which are permitted to rotate while the sleeve portion 214 remains fixed.

The lateral faces of each of the first and second rotary elements have a plurality of openings (not shown) disposed in a ring pattern. As will be explained in greater detail below, these openings are alignable with corresponding openings formed in the upper ends 230 of the lateral, obround-shaped, connector arms 224 and 226 to permit the insertion of fasteners 228 therethrough to secure the first and second rotary elements to the connector arms 224 and 226.

It will be appreciated that the second rotary actuator 192 in combination with the lateral connector arms 224 and 226 defines a horizontal hinge operable to permit the support frame 42 to pivot about the second axis of rotation H₁. When the second rotary actuator 192 is actuated, the action of the pressurized hydraulic fluid within the rotary assembly urges the sleeve portion 214 to pivot relative to the rotary elements which are fixed to the connector arms 224 and 226. This rotary motion is transferred to the support frame 42 (and ultimately, to the drive block 42 and propeller 46).

In this embodiment, the second rotary actuator 192 is also a hydraulic rotary actuator manufactured by Helac Corporation® (Enumclaw, Wash., U.S.A.) and sold under the L-20 Series™ brand name.

While it is generally preferred that the support frame movement mechanism 100 employ rotary actuators in a dual hinge design because of ease of use and manufacturing, it will be appreciated that alternate movement imparting mechanisms could be used to similar advantage. For instance, in another embodiment, the support frame movement mechanism could take the form of linear actuators or even an arrangement of cable pulleys.

With reference to FIGS. 5, 7 and 8, the support frame 42 is now described in greater detail. The support frame 42 has a generally trapezoidal shape when seen in a top plan view. It includes a base portion 240 and an upper portion 242 connected to the base portion 240. The base portion 240 is defined by a pair of first and second, spaced apart, longitudinal members 244 and 246, a first intermediate cross-member 248 and an end cross-member 250. Each longitudinal member 244, 246 has a first end 252, 254 and a second end 256, 258, respectively. In this embodiment, the longitudinal members 244 and 246 are not disposed parallel to each other. Rather, the distance between the first ends 252 and 254 of the longitudinal members 244 and 246 is greater than the distance between the second ends 256 and 258, such that the base portion 240 is wider at the region of the first ends 252 and 254 than in the region of the second ends 256 and 258. At a location closer to second ends 256 and 258 than to the first ends 252 and 254, the first intermediate cross-member 248 extends between and joins the first longitudinal member 244 to the second longitudinal member 246. The end cross-member 250 is welded to each longitudinal member 244 and 246 at its respective second end 252, 254.

The top portion 242 also includes a pair of third and fourth, spaced apart, longitudinal members 260 and 262 connected to the end cross-member 250 and a second intermediate cross-member 264. Each of third and fourth longitudinal members 260 and 262 has a first end 266, 268 and an opposed second end 270, 272, respectively. When viewed in top plan as shown in FIG. 7, the third and fourth longitudinal members 260 and 262 are seen to be arranged similarly to the first and second longitudinal members 244 and 246, with the top portion 242 being is wider at the region of the first ends 266 and 268 than in the region of the second ends 270 and 272. Each longitudinal member 260 and 262 is cut on an angle at its respective first end 266, 268 to facilitate the welding of the members to the end-cross member 250 and to allow the longitudinal members 260 and 262 to be carried above the base portion 240 at an incline (as best shown in FIG. 8). In this embodiment, the angle formed between the end cross-member 250 and the longitudinal members 260 and 262 is 20 degrees. In like fashion to the first intermediate cross-member 248, the second intermediate cross-member 264 joins the third longitudinal member 260 to the fourth longitudinal member 262 at a location closer to second ends 270 and 272 than to the first ends 266 and 268.

In this embodiment, the longitudinal members and the cross-members are all hollow aluminum structural members. In other embodiments, these members may be fabricated from steel or other suitable materials. The first and second longitudinal members 244 and 246, the third and fourth longitudinal members 260 and 262, the first and second intermediate cross-members 248 and 264, and the end cross-member 250 cooperate with each other to define a generally trapezoidal station 278 which is sized to receive the engine block 44.

The second end 256 of the first longitudinal member 244 is joined to the second end 270 of the third longitudinal member 260 by a first vertically extending panel 280. Similarly, a second vertically extending panel 282 connects the second end 258 of the second longitudinal member 246 to the second end 272 of the fourth longitudinal member 262. Each panel 280, 282 includes a lower end 284 welded to the inside face of the longitudinal member 244 or 246 (as the case may be) and an upper end 286 welded to the inside face of the longitudinal member 260 or 262 (as the case may be). The upper end 286 of each panel 280, 282 is truncated to match the profile of the upper face of the third and fourth longitudinal members 260 and 262. When viewed from the side (as shown in FIG. 8), the first and third longitudinal member 244 and 260 and the panel 280 on one side, and the second and fourth longitudinal members 246 and 262 and the panel 282 on the other side, each have a generally triangular structure which tends to be well-suited for resisting bending moments acting on the support frame 42.

Extending between the lower and upper ends 284 and 286 of the panels 280, 282 are opposed vertically extending side edges 288 and 290. Formed in the side edge 288 of each panel 280, 282 (that is, the side edge furthest from the end cross-member 250) is a generally semi-circular cutout 292 sized to accommodate therein a substantial portion of a tubular cross-member 294. As best shown in FIGS. 6 and 8, the tubular cross-member 294 is carried below, and parallel to, the second rotary actuator 192. It extends horizontally between the panels 280 and 282 and is welded thereto where its radial edges meet the side edges 290. At locations inwardly of the panels 280 and 282, the tubular cross-member 294 joins the lateral connector arms 224 and 226 which depend downwardly from the second rotary actuator 192. More specifically, the tubular cross-member 294 is received through large apertures defined in the lower ends 300 of the connector arms 224 and 226 and is fixedly secured thereto by welding along those radial edges abutting the connector arms 224 and 226. When the second actuator assembly 192 is actuated, the rotary motion from the rotary elements is transmitted through the connector arms 224 and 226 to the tubular cross-member 294. By reason of its fixed attachment to the panels 280 and 282, the rotary motion of tubular cross-member 294 is imparted to the panels 280 and 282 (and ultimately, to the base portion 240 and top portion 242) thereby effecting rotation of the support frame 42.

As best shown in FIGS. 6 and 10, the tubular cross-member 294 has an abutment pad or stop 296 attached to its sidewall 298 midway between the lateral connector arms 224 and 226. The outer face of the stop 296 is indented concavely to correspond closely to the arcuate profile of the tubular post member 186. As explained in greater detail below, the stop 296 forms part of the support frame movement restricting means 410. More specifically, when the support frame 42 is pivoted to its lower limit position 406, the stop 296 is urged against the sidewall 185 of the tubular post member 186, thereby preventing any further downward movement of the support frame 42.

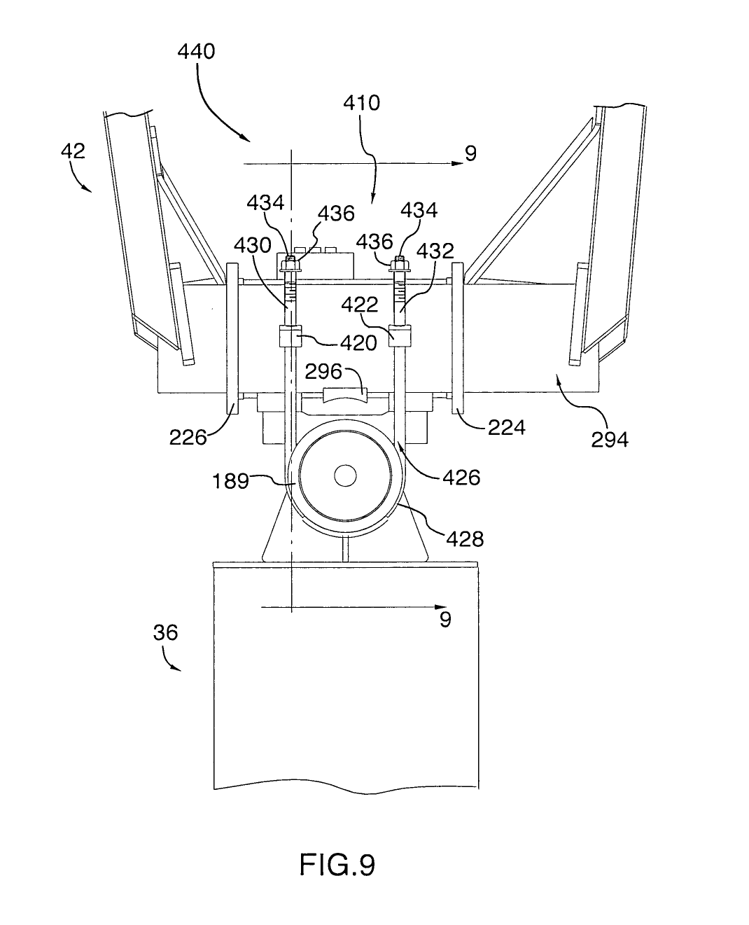

A pair of relatively small, spaced apart, lugs 420 and 422 are welded to the underside of the tubular cross-member 294 between the connector arms 224 and 226 (see FIG. 9). Each lug 420 and 422 has a substantially trapezoidal bore 424 defined therein oriented generally perpendicular to the tubular cross-member 294. Each bore 424 is sized to receive therethrough a portion of the U-shaped retaining rod 426.

As best shown in FIG. 7, the support frame 42 is further provided with reinforcement members in the nature of diagonal braces 302 and 304, and struts 306 and 308. The brace 302 includes a relatively short, straight portion 310 and a relatively longer, dog-legged portion 312 joined to the straight portion 310. The straight portion 310 is welded to the inner face of the fourth longitudinal member 262 adjacent the second intermediate cross-member 264, while the terminal end of the dog-legged portion 312 is welded to the outer face of the connector arm 224. The brace 304 has a structure generally similar to that of brace 302 in that it too has a relatively short, straight portion 314 and a relatively longer, dog-legged portion 316 joined to the straight portion 314. However, the dog-legged portion 316 is shorter than the dog-legged portion 312. In the case of brace 304, the straight portion 310 is welded to the inner face of the third longitudinal member 260 a short distance away from the second intermediate cross-member 264, while the terminal end of the dog-legged portion 316 is welded to the outer face of the connector arm 226.

In this embodiment, the strut 306 takes the form of a flat bar 320 having a first end 322 and a second end 324. The strut 306 is mounted to extend between connector arm 226 and the panel 282, more specifically, with its first end 322 welded to the outer face of the connector arm 226 adjacent the terminal end of the dog-legged portion 312 and its second end 324 fixed to the inner face of the panel 282. The strut 308 is generally similar to strut 306 in that it too is a flat bar 330 having first and second ends 332 and 334. However, the strut 308 is relatively shorter than the strut 306. The first end 332 of the strut 308 is welded to the outer face of the connector arm 224 adjacent the terminal end of the dog-legged portion 316, while its second end 334 is fixed to the inner face of the panel 280.

As best shown in FIG. 7, the support frame 42 is not symmetrical about its longitudinal midline “M”. The first and second rotary actuators 190 and 192 are not centered between the first and second longitudinal members 244 and 246. Rather, the actuators 190 and 192 and the attachment site to spacer means 36 are offset toward the first and third longitudinal members 244 and 260. This configuration is intended to accommodate the distribution of forces and moments acting on the support frame 42 when the propeller 46 is driven to rotate and the actuators 190 and 192 are actuated, and to account for the fact that, in this embodiment, the center of mass of the engine block 44 is not positioned at the geometric center of the engine block 44.

In alternate embodiments, the support frame could be configured differently. Moreover, while in this embodiment the support frame 42 and the support frame movement mechanism 100 are distinct components, it is possible that in other embodiments, the function of the movement mechanism could be more closely incorporated in the structure of the support frame.

Referring now to FIGS. 4, 11 and 14, there is shown the engine block 44 and propeller 46 carried by the support frame 42. In this embodiment, the engine block 44 is supported on, and fixed to, the cross-members 250 and 264 of the base portion 240. However, in other embodiments, the engine block could be attached differently to the base portion of the support frame. While not shown in the figures, the engine block 44 is encased in a protective cowling.

In this embodiment, the engine block 44 includes an 82 h.p. diesel-powered combustion engine 340 operatively connected to the propeller. The engine 340 is a conventional engine that has been modified to incorporate a propeller speed reduction unit (not shown) and a dry sump system to ensure continual flow of lubricating oil to the engine 340 even when the engine block 44 is tilted upwardly or downwardly. In alternative embodiments, the propulsion and steering assemblies 32 could be powered by other types of engines. For instance, gasoline, propane or natural gas powered combustion engines could be employed. Alternatively, turbine engines or electric motors powered by generators may be used. In a further alternative, it may be possible to power the assemblies with solar cells or fuel cells.

The propeller 46 is operatively coupled to a drive shaft (not visible) extending from the engine 340 with sufficient clearance provided between the propeller 46 and the end cross-member 250. In this embodiment, the propeller 46 is a push-type propeller provided with three blades 342. The diameter of the propeller 46 measures 10 ft. In alternative embodiments, the propeller could be a pull-type propeller with three blades (or a greater or lesser number of blades). Additionally, the diameter of the propeller could be sized differently based on the thrust required to be produced. For instance, if less thrust is required to be produced, then a smaller diameter propeller may be used (e.g. 6 ft. diameter propeller). Alternatively, if more thrust is required a propeller having a larger diameter could be employed.

The support frame movement restricting means 410 is now described in greater detail with reference to FIGS. 9 to 16. In this embodiment, the movement restricting means 410 is partially defined on the one hand, by the stop 296 carried on the tubular cross-member 294, and on the other hand, by the U-shaped rod 426 captively retained at one end by the flange 189 of the tubular post member 186, and at the other end by the lugs 420 and 422. As concerns the U-shaped rod 426 it includes an arcuate portion 428 and a pair of parallel arms 430 and 432 joined to the curved portion 428. The radius of curvature of the arcuate portion 428 is sized slightly larger than that of the sidewall 185 of the tubular post member 186 to allow it to be received within the flange 189. At their respective terminal ends 434, each arm portions 430, 432 is threaded to allow threaded engagement with a nut 436. The arm portion 430 is received within the bore 424 of the lug 420 and similarly, the arm portion 432 extends through the bore 424 of the lug 422. In each case, the fastening of the nuts 436 on the terminal ends 434 of the arm portions 430 and 432, prevents the arm portions from becoming disengaged from the lugs 420 and 422. The nuts 436 are sized larger than the bores 424 defined in the lugs 420 and 422.

As best shown in FIGS. 9 and 10, when the support frame 42 is in the outward orientation or intermediate position 440 (i.e. the support frame is midway between the first and second limit positions 400 and 402, and midway between the upper and lower limit positions 404 and 406), the stop 296 is spaced from the sidewall 185 of the tubular post member 186 and the arcuate portion 428 of the retaining rod 426 is carried at the same height as the arm portions 430 and 432.

The movement restricting means 410 further includes an internal stop (not shown) built into each of the rotary actuators 190 and 192 which may be set to limit travel to a predetermined angle. Additionally, the actuator controller is operable to limit rotational movement of the support frame 42. In an alternative embodiment, the movement restricting means could be configured without a tubular post member, stop and U-shaped rod arrangement. In such an embodiment, the movement restricting function could be performed by the internal stops built into the rotary actuators.

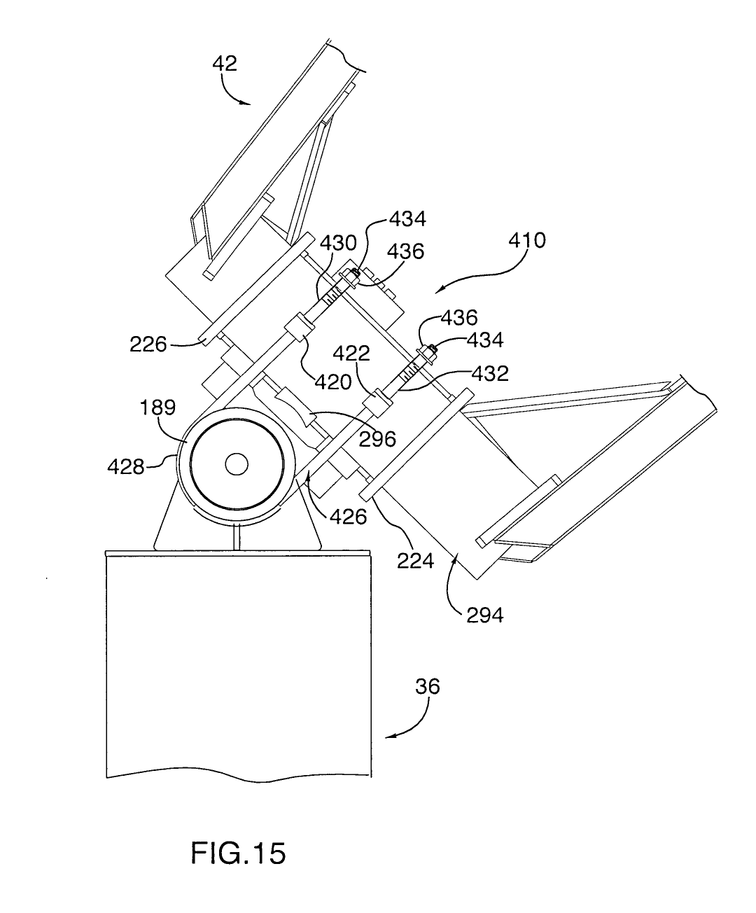

An exemplary description of the operation of the support frame movement mechanism 100 and the movement restricting means 410 is now described. To pivot the support frame 42 about the first rotational axis V₁, the pilot of the airship 10 actuates the first rotary actuator 190 to urge the sleeve portion 200 to rotate relative to the upper and lower rotary elements. As previously mentioned, the support frame 42 is constrained to move between the first and second limit positions 400 and 402. When the support frame 42 reaches the first or second limit position 400 or 402, the movement restricting means 410 engages and prevents any further rotational movement of the support frame 42 about the first rotational axis V₁. When, for example, the second limit position 402 is reached (as shown in FIG. 15), the internal stop within the first rotary actuator 190 operates to block any further rotation of the support frame 42 in that direction.

A first angle θ₁ is defined between the first limit position 400 and the intermediate position 440. Similarly, a second angle θ₂ is defined between the second limit position 402 and the intermediate position 440. In this embodiment, the first and second angles θ₁ and θ₂ are equal to each other and measure 45 degrees. The rotational range of motion for the support frame 42 between the first limit position 400 and the second limit position 402 is thus 90 degrees.

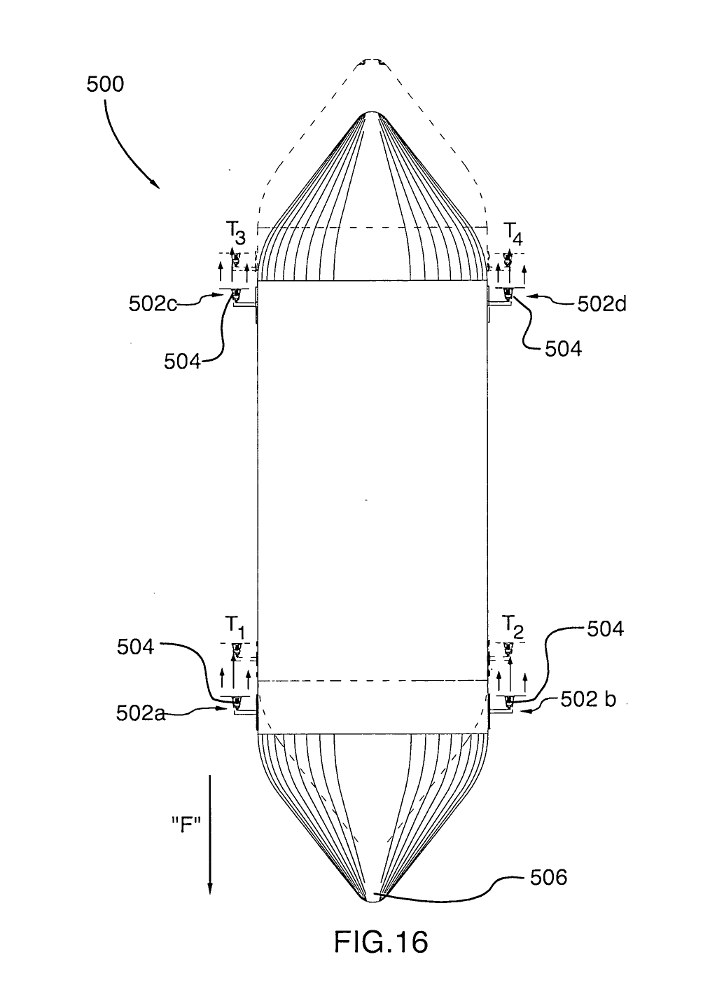

In other embodiments, the values of angles θ₁ and θ₂ could be increased or decreased to suit a particular application. For example, in one alternative embodiment, the support frame movement mechanism 100 could be modified to permit the angles θ₁ and θ₂ to reach 90 degrees each to thereby afford the support frame with 180 degrees of rotational range of motion about the first rotational axis V₁. This rotational range of motion would provide an airship equipped with such propulsion and steering assemblies enhanced steering capabilities as described in greater detail below. Such an embodiment is shown in FIGS. 16 to 19, wherein the alternate airship is designated with reference numeral 500 and first, second, third and fourth modified propulsion and steering assemblies are designated, respectively, with reference numerals 502a, 502, 502c and 502d (and collectively, with reference numeral 502). The modifications to the support frame movement mechanism of the assemblies 502 could include, for example, lengthening the upper and lower arms of the connecting bracket (which carry the first rotary actuator) so as to create sufficient clearance between the support frame and the spacer means when the support frame is moved to either the first limit position or the second limit position. It will be appreciated that the increased rotational range of motion described above could be achieved with other modifications to the support frame movement mechanism and/or the support frame.

While it is generally preferred that angles θ₁ and θ₂ be equal to each other that need not be the case in every application. In certain applications, it may be desirable to have one of the angles θ₁ and θ₂ larger than the other so as to provide a greater range of motion in one direction than in the other.

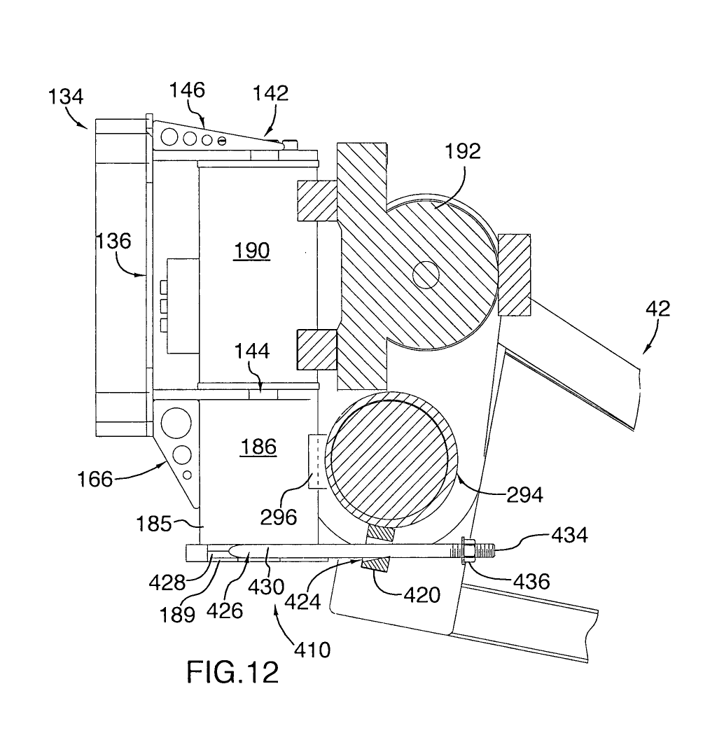

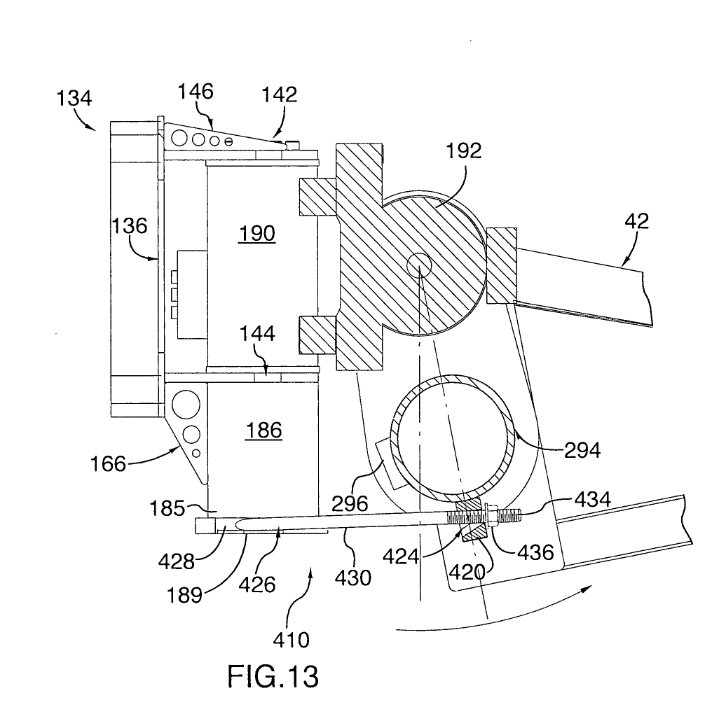

To pivot the support frame 42 about the second rotational axis H₁, the pilot of the airship 10 actuates the second rotary actuator 192 to urge the first and second rotary elements to rotate relative to the sleeve portion 214. As previously mentioned, the support frame 42 is constrained to move between the upper and lower limit positions 404 and 406. When the support frame 42 reaches the upper limit position 404, the movement restricting means 410 engages and prevents any further rotational movement of the support frame 42 about the second rotational axis H₁. More specifically, the nuts 436 fastened to the arm portions 430 and 432 bear against the lugs 420 and 422 and prevent any further travel of the arm portions 430 and 432 within their respective lugs 420 and 422, thereby blocking further rotation in the upward direction (see FIG. 13). At this stage, the arm portions 430 and 432 are carried at a height slightly higher than the arcuate portion 428. When the support frame 42 reaches the lower limit position 404, the stop 296 bears against the sidewall 185 of the tubular post member 186 and prevents any further rotation in the downward direction (see FIG. 12).

A third angle θ₃ is defined between the upper limit position 404 and the intermediate position 440. Similarly, a fourth angle θ₄ is defined between the lower limit position 406 and the intermediate position 440. In this embodiment, the angles θ₃ and θ₄ are equal to each other and measure 11 degrees. The rotational range of motion for the support frame 42 between the upper limit position 404 and the lower limit position 406 is thus 22 degrees.

In other embodiments, the values of angles θ₃ and θ₄ could be increased or decreased to suit a particular application. For example, in one alternative embodiment, the support frame movement mechanism 100 could be modified to permit the angles θ₃ and θ₄ to reach 90 degrees each to thereby afford the support frame 42 with 180 degrees of rotational range of motion about the second rotational axis H₁. This rotational range of motion would provide an airship equipped with such propulsion and steering assemblies enhanced steering capabilities as described in greater detail below. Such an embodiment is shown in FIGS. 16 to 19. The modifications to the support frame movement mechanism could include, for example, configuring such mechanism without a tubular post member, stop and U-shaped rod arrangement and increasing the depth of the first and second lateral mounting cross-members of the second rotary actuator so as to create sufficient clearance between the support frame and the support frame movement mechanism. Of course, the increased rotational range of motion described above could be achieved with other modifications to the support frame movement mechanism and/or the support frame.

While it is generally preferred that angles θ₃ and θ₄ be equal to each other that need not be the case in every application. In certain applications, it may be desirable to have one of the angles θ₃ and θ₄ larger than the other so as to provide a greater range of motion in one direction than in the other.

Generally speaking, the greater the values of angles θ₁, θ₂, θ₃ and θ₄ the greater rotational range of motion afforded to the airship 10 and the more maneuverable it becomes.

Having described the structure of a representative propulsion and steering assembly, an exemplary use of the assemblies 32a, 32b, 32c and 32d to propel and steer the airship 10 is now described. When all engines 340 are powered up, the first propulsion and steering unit 32a produces a first thrust T₁, the second propulsion and steering assembly 32b produces a second thrust T₂, the third propulsion and steering assembly 32c produces a third thrust T₃ and the fourth propulsion and steering unit 32d produces a fourth thrust T₄. When, as shown in FIG. 2, the support frames 42 of each of the assemblies 32a, 32b, 32c and 32d are in their respective intermediate positions 440, the airship 10 is at a standstill with the thrust T₁ counteracting the thrust T₂ and the thrust T₃ counteracting the thrust T₄. This arrangement tends to be useful in applications where it is desirable to have the airship 10 hover over a particular site.

To steer the airship 10 in a desired direction of travel and/or impart the desired motion (i.e. pitch, yaw or roll motion, or any combination of the foregoing) thereto, the pilot of the airship 10 will actuate one or more of the rotary actuators 190 and 192 of one or more of the assemblies 32a, 32b, 32c and 32d, so as to urge one or more of the support frames 42 to move relative to the hull 12. The movement of one or more of the support frames 42 will permit one or more of the thrusts T₁, T₂, T₃, T₄ to be oriented in an direction opposite to the desired direction of travel, thereby steering and propelling the airship in the desired direction of travel.

Examples of the types of steering operations that can be executed using the propulsion and steering assemblies 502, are described below with reference to FIGS. 16 to 19. FIG. 16 shows the support frames 504 of the first, second third and fourth propulsion and steering assembly 502a, 502b, 502c and 502d pivoted rearward to their respective aft limit positions. In this arrangement, the thrusts T₁, T₂, T₃ and T₄ produced by the assemblies 502 are oriented rearward thereby propelling the airship 500 linearly in a forward direction indicated by the arrow “F”. To propel the airship 500 linearly in the rearward direction, the support frames 504 of the assemblies 502 are pivoted forward to their respective fore limit positions.

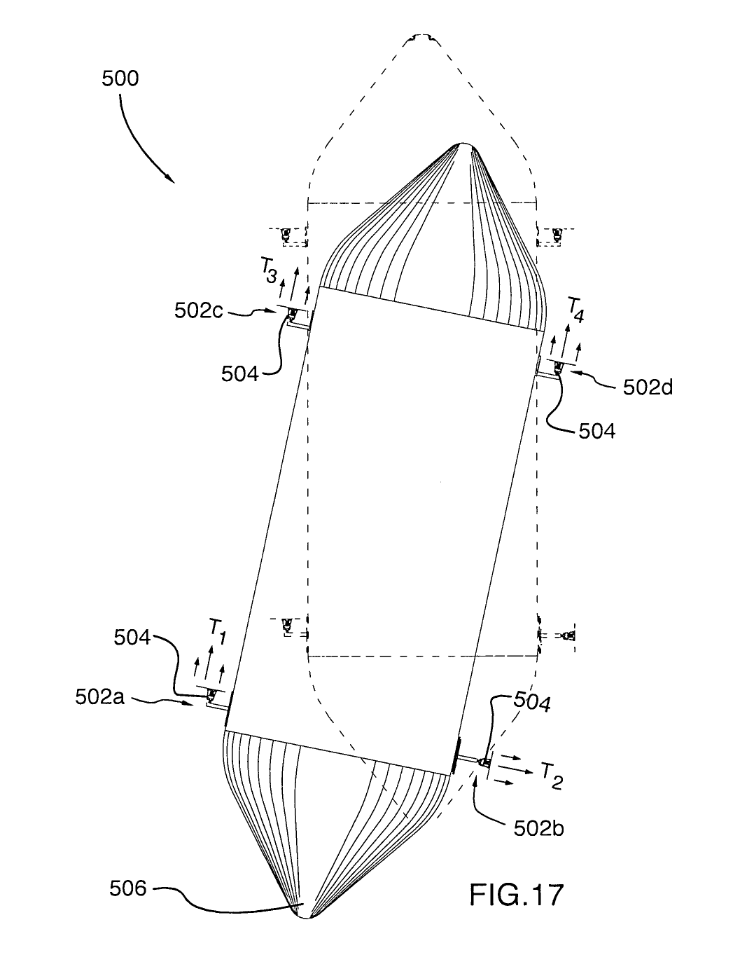

FIG. 17 shows the support frames 504 of the first, third and fourth propulsion and steering assemblies 502a, 502c and 502d all pivoted to their respective aft limit positions and the support frame of the second propulsion and steering assembly 502c in its intermediate position. In this arrangement, the thrusts T₁, T₃ and T₄ produced by the assemblies 502a, 502c and 502d are oriented rearward while the thrust T₂ produced by the assembly 502b is oriented laterally or outwardly. The resulting motion imparted to the airship 500 is generally in the forward direction with the nose 506 of the airship 500 turning in a direction opposite to the lateral orientation of the support frame 504 of assembly 502b. This type of arrangement is useful for effecting a yaw motion.

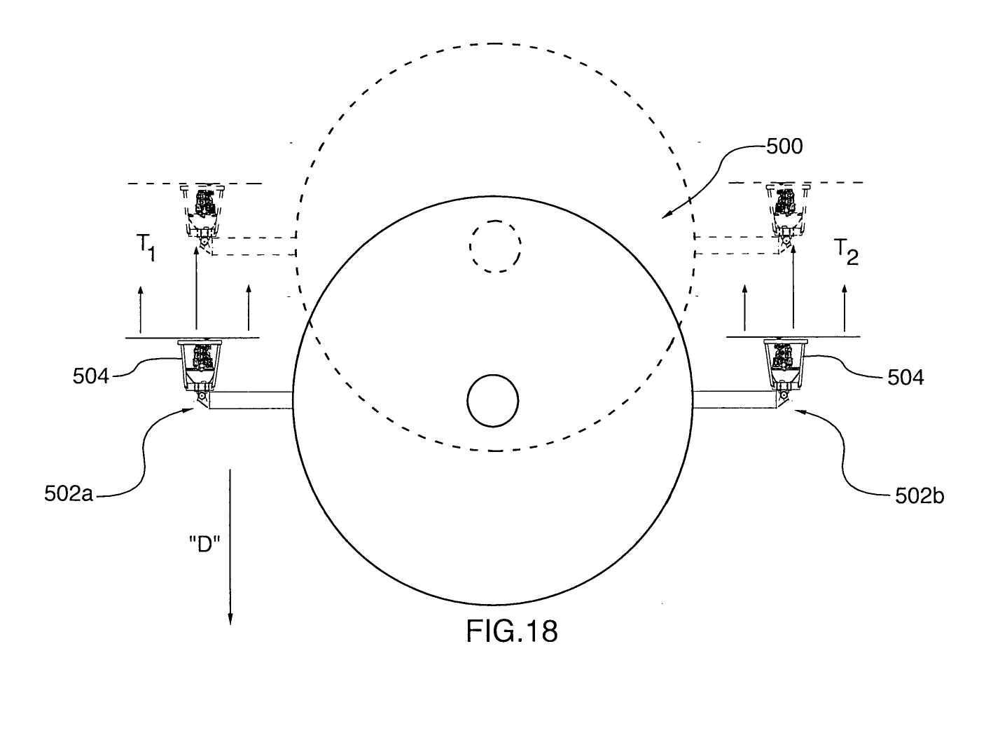

FIG. 18 shows the support frames 504 of the first, second, third and fourth propulsion and steering assemblies 502a, 502b, 502c and 502d all pivoted to their respective upper limit positions. In this arrangement, the thrust T₁, T₂, T₃ and T₄ produced by the assemblies 502a, 502c and 502d are oriented upward thereby propelling the airship 500 in a generally downward direction indicated by arrow “D”. Advantageously, this type of propulsion and steering capability could substantially facilitate landing of the airship 500 and could operate to reduce the need for the presence of significant ground crews during landing operations.

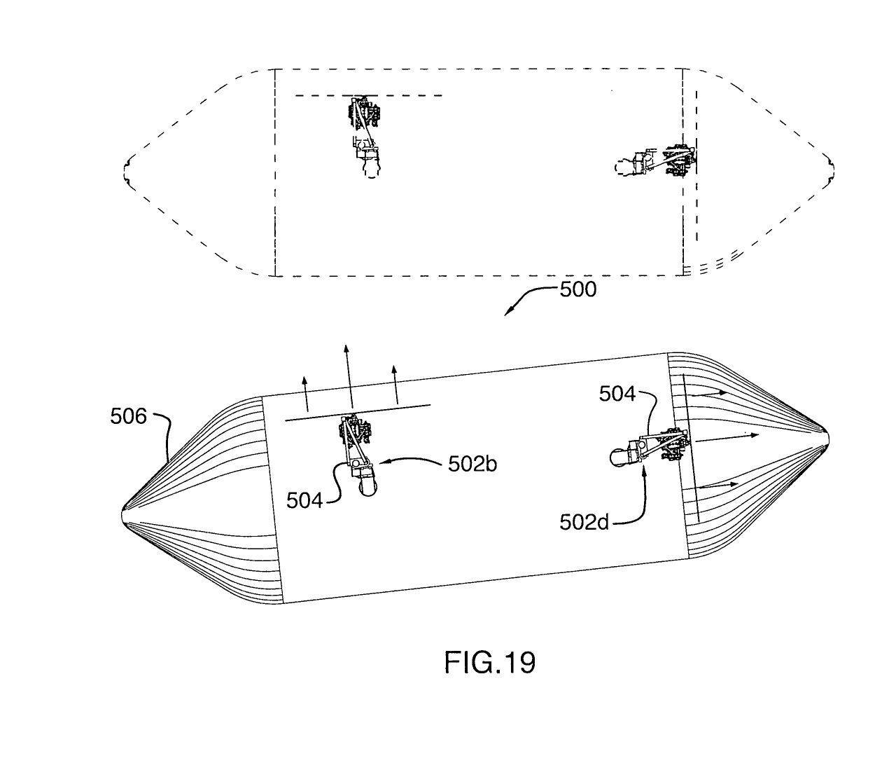

FIG. 19 shows the support frames 504 of the fore pair of (first and second) propulsion and steering assemblies 502a and 502b pivoted to their respective upper limit positions and the support frames 504 of the aft pair of (third and fourth) propulsion and steering assemblies 502c and 502d pivoted to their respective aft limit positions. In this arrangement, the thrusts T₁ and T₂ produced by the assemblies 502a and 502b are oriented upward thereby propelling the nose 506 of the airship 500 downward, while the thrusts T₃ and T₄ produced by the assemblies 502c and 502d are oriented rearward thereby propelling the airship 500 forward. The resulting motion imparted to the airship 500 is a pitch motion, which tends to be particularly useful for effecting a descent maneuver. Of course, an ascent maneuver could be performed by pivoting the support frames 504 the fore pair of (first and second) propulsion and steering assemblies 502a and 502b to their respective lower limit positions, while maintaining the support frames 504 of the aft pair of (third and fourth) propulsion and steering assemblies 502c and 502d in their respective aft limit positions.

Other maneuvers may be performed using the propulsion and steering assemblies 502. For instance, a roll motion may be imparted to the airship 500 by pivoting the support frames of the second and fourth assemblies 502b and 502d upwardly or downwardly while pivoting the support frames of the first and third assemblies 502a and 502c in the opposite direction. It will be further appreciated that any combination of yaw, roll and pitch movements may be used in order to maneuver the airship 500 as desired. Moreover, each of the assemblies 502a, 502b, 502c and 502d may be pivoted independently in order to orient their respective thrusts T₁, T₂, T₃, and T4 to achieve the desired attitude for the airship 500.

As will be appreciated by a person skilled in the art, by reason of its design and configuration, a propulsion and steering system constructed in accordance with the principles of the present invention tends to permit more efficient orientation of the thrust produced, thereby tending to minimize loss of thrust (and power). In the result, a more powerful and responsive propulsion and steering system is obtained. Such a system is particularly useful for steering airships during very low speed approaches (e.g. landings or take-offs) or other maneuvers requiring precise positioning of the airship. Advantageously, this innovative propulsion and steering system allows an airship to perform tasks which conventional airships tend to be ill-suited to perform. For instance, an airship outfitted with a propulsion and steering system constructed in accordance with the principles of the present invention could be successfully employed in the following applications: it could be used to load or unloading goods while hovering; in the case of a heavy-lift airship, it could be used to precisely position a heavy load; it could be used to perform aerial geophysical surveys which require that the airship accurately follow both the “survey line” and the contour of the land being surveyed; and in cases where the airship is used in search and rescue applications, it could be employed to hover precisely over a specific location to allow a person or equipment to be hoisted up onto the airship using a winch.

Furthermore, the type of propulsion and steering system described and shown in this application tends to weigh less than prior art propulsion and steering systems, thereby offering the potential for cost savings on fuel and even increased payload capacity.

Although the foregoing description and accompanying drawings relate to specific preferred embodiments of the present invention as presently contemplated by the inventor, it will be understood that various changes, modifications and adaptations, may be made without departing from the spirit of the invention.

What is claimed is:

1. A propulsion and steering assembly for use with an airship, the airship including a hull having an outer envelope, the assembly comprising:
an engine for producing thrust to propel the airship;
a support frame for carrying the engine, the engine being fixed to the support frame;
a support frame movement mechanism operable to move the support frame relative to the hull to thereby allow the engine and the thrust produced by the engine to be oriented in a desired direction;
spacer means connected to the support frame movement mechanism for spacing the support frame and the engine from the outer envelope of the hull so as to create sufficient clearance therebetween when the support frame is moved; and
a mounting framework for attaching the spacer means to the hull.

2. The assembly of claim 1, further comprising a propeller operatively connected to the engine.

3. The assembly of claim 2, wherein the propeller is selected from the group consisting of: (a) a push-type propeller; (b) a pull type propeller.

4. The assembly of claim 1, wherein the support frame movement mechanism includes a dual hinge assembly.

5. The assembly of claim 1, wherein the support frame movement mechanism includes a first actuator for imparting rotary movement to the support frame about a first axis of rotation, and a second actuator for imparting rotary movement to the support frame about a second axis of rotation; the first axis of rotation being perpendicular to the second axis of rotation.

6. The assembly of claim 1, wherein:
the support frame depends from the second rotary actuator;
the second rotary actuator is carried by the first rotary actuator; and
the first rotary actuator is mounted to the spacer means.

7. The assembly of claim 1, wherein:
the support frame depends from the first rotary actuator;
the first rotary actuator is carried by the second rotary actuator; and
the second rotary actuator is mounted to the spacer means.

8. The assembly of claim 5, wherein the first and second rotary actuators are hydraulic actuators.

9. The assembly of claim 5, wherein the first and second rotary actuators are selected from the group consisting of pneumatic actuators and electric actuators.

10. The assembly of claim 5, wherein the first actuator is operable to pivot the support frame and the engine between a first lateral limit position and a second lateral limit position.

11. The assembly of claim 10, wherein:
an angle is defined between the first and second lateral limit positions; and
the angle is less than or equal to approximately 180.

12. The assembly of claim 10, wherein the second actuator is operable to pivot the support frame and the engine between an upper limit position and a lower limit position.

13. The assembly of claim 12, wherein:
an angle is defined between the upper and lower limit positions; and
the angle is less than or equal to approximately 180.

14. The assembly of claim 12, further comprising means for restricting movement of the support frame between the first and second lateral limit positions, and between the upper and lower limit positions.

15. The assembly of claim 1, wherein the spacer means includes an elongate structural member supported from the mounting framework in a cantilevered fashion.

16. The assembly of claim 1, wherein the mounting framework is curved convexly to closely correspond to the radius of curvature of the hull to encourage close contact therebetween and facilitate attachment of the mounting framework to the hull.

17. An airship comprising:
a hull having an outer envelope;
a propulsion and steering system operatively connected to the outer envelope of the hull, the system having:
at least one propulsion and steering assembly including:
an engine for producing thrust to propel the airship;
a support frame for carrying the engine, the engine being fixed to the support frame;
a support frame movement mechanism operable to move the support frame relative to the hull to thereby allow the engine and the thrust produced by the engine to be oriented in a desired direction;
spacer means connected to the support frame movement mechanism for spacing the support frame and the engine from the outer envelope of the hull so as to create sufficient clearance therebetween when the support frame is moved; and
a mounting framework for attaching the spacer means to the hull.

18. The airship of claim 17, wherein the hull is has an elongated body.

19. The airship of claim 18, wherein:
the hull includes a first conical end portion, a second end conical portion and a cylindrical intermediate portion extending between the first and second conical portions; the intermediate portion having a sidewall;
the at least one propulsion and steering assembly includes a first propulsion and steering assembly and a second propulsion and steering assembly; and
the first and second propulsion and steering assemblies are mounted to the sidewall of the intermediate portion in opposition to each other.

20. The airship of claim 19, wherein:
the at least one propulsion and steering assembly further includes a third propulsion and steering assembly and a fourth propulsion and steering assembly;
the third and fourth propulsion and steering assemblies are mounted to the sidewall of the intermediate portion in opposition to each other.

21. The airship of claim 20, wherein:
the first and second propulsion and steering assemblies define a fore pair of steering and propulsion assemblies; and
the third and fourth propulsion and steering assemblies define an aft pair of steering and propulsion assemblies.

22. The airship of claim 21, wherein:
the fore pair of steering and propulsion assemblies is disposed on a first plane;
the aft pair of steering and propulsion assemblies is disposed on a second plane; and
the first plane is the same as the second plane.

23. The airship of claim 21, wherein:
the fore pair of steering and propulsion assemblies is disposed on a first plane;
the aft pair of steering and propulsion assemblies is disposed on a second plane; and
the first plane is different than the second plane.

24. The airship of claim 21, wherein:
the fore pair of steering and propulsion assemblies is mounted to the intermediate portion adjacent the first conical end portion; and
the aft pair of steering and propulsion assemblies is mounted to the intermediate portion adjacent the second conical end portion.

25. The airship of claim 17, wherein the hull of the airship is spherical.

26. A kit for a steering and propulsion assembly for use with an airship, the airship including a hull having an outer envelope, the assembly being mountable to the outer envelope of the hull, the kit comprising:
an engine for producing thrust to propel the airship;
a support frame for carrying the engine, the engine being fixable to the support frame;
a support frame movement mechanism operable to move the support frame relative to the hull to thereby allow the engine and the thrust produced by the engine to be oriented in a desired direction;
spacer means connectable to the support frame movement mechanism for spacing the support frame and the engine from the outer envelope of the hull so as to create sufficient clearance therebetween when the support frame is moved; and
a mounting framework connectable to the spacer means and fixable to the hull.

27. A method of steering and propelling an airship comprising the steps of:
providing an airship, the airship including a hull having an outer envelope;
providing a propulsion and steering system operatively connected to the outer envelope of the hull, the system having:
at least one propulsion and steering assembly including:
an engine for producing thrust to propel the airship;
a support frame for carrying the engine, the engine being fixed to the support frame;
a support frame movement mechanism operable to move the support frame relative to the hull to thereby allow the engine and the thrust produced by the engine to be oriented in a desired direction;
spacer means connected to the support frame movement mechanism for spacing the support frame and the engine from the outer envelope of the hull so as to create sufficient clearance therebetween when the support frame is moved; and
a mounting framework for attaching the spacer means to the hull;
actuating the engine to produce thrust;
actuating the support frame movement mechanism to urge the support frame to move relative to the hull;
orienting the thrust produced by the engine in a direction opposite to the desired direction of travel; and
steering and propelling the airship in the desired direction of travel.
